(19) United States
(12) Patent Application Publication
(10) Pub. No.: US 2021/0325302 A1
(43) Pub. Date: Oct. 21, 2021

(54) Determination of Margin in Freshly Resected Tissue Specimens Using Tumor Responsive Tissue Marking Dye

(71) Applicant: CytoVeris Inc., Farmington, CT (US)

(72) Inventors: Alan Kersey, South Glastonbury, CT (US); Michael A. Sapack, Southbury, CT (US); Patrick M. Curry, Glastonbury, CT (US)

(21) Appl. No.: 17/236,962

(22) Filed: Apr. 21, 2021

Related U.S. Application Data
(60) Provisional application No. 63/013,291, filed on Apr. 21, 2020.

(51) Int. Cl. G01N 21/64; G01N 1/31; G01N 21/65

(52) U.S. Cl. CPC G01N 21/6428; G01N 2001/302; G01N 21/65; G01N 1/31

(57) ABSTRACT

A tumor responsive tissue marking dye is provided that includes a tissue marking dye and at least one cancer activated agent. The at least one cancer activated agent is configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state.

This application claims the benefit of U.S. Provisional Application No. 63/013,291, filed Apr. 21, 2020, which application is hereby incorporated by reference in its entirety.

### BACKGROUND OF THE INVENTION

### 1. Technical Field

The present disclosure relates to tissue marking dyes, systems, and methods for marking tissue sites in general, and to tissue marking dyes, systems, and methods operable to determine tissue properties at a tissue margin.

### 2. Background Information

For many decades, the reference method for the diagnosis of cancer has been histopathological staining and examination of tissues using conventional microscopy. This process is known as Surgical Pathology. In Surgical Pathology, samples can be produced from surgical procedures (tumor resection), diagnostic biopsies or autopsies. These samples typically go through a process that includes dissection, fixation, and cutting of tissue into precisely thin slices which are stained for contrast and mounted onto glass slides. The slides are examined by a pathologist under a microscope, and the pathologist's interpretation of the tissue results in the pathology “read” of the sample. While this represents the “gold standard” in the assessment of tumor versus normal tissue, this process usually takes days to a week, and is thus a “post-surgical” process.

Current surgical techniques to resect cancer are limited by the lack of a precise method to determine the boundary between normal cells and cancerous cells, known as the “tumor margin”, in real time during surgical procedures. Consequently, the success of such surgical procedures relies on the experience and judgement of the surgeon to decide how much tissue to remove around the tumor. As a result, surgeons often perform what is called cavity shaving, which can result in the removal of excessive amounts of healthy tissue. Conversely, for many patients, post-operative surgical pathology results show that the entire tumor was not removed during the initial surgery, necessitating a follow up surgery to remove residual cancer tissue. This can be traumatic to the cancer patient, adding stress and resulting in long-term detrimental effects on the patient outcome.

To help the surgeon to resect all the cancer tissue and improve patient outcomes, surgical guidance technologies are needed in order to assess the completeness of the removal of the cancer tissue in real time during the operation.

Advanced optical and electromagnetic (EM) imaging approaches have been reported for the determination of tumor margin. These imaging approaches include the use of fluorescence imaging [1-2], including topically administered tumor-targeted fluorescent dyes [3], near infrared spectroscopy [4], Raman spectroscopy [5], surface enhanced Raman spectroscopy (SERS) [6], and terahertz reflectivity [7]. Additionally, the use of mass spectrometry to profile tumor tissue/normal tissue boundaries has been reported [8]. The latter methodology uses a mass spectrometer coupled to a “pen” that allows testing of tumor tissue by determination and differentiation of the metabolic products produced by cancerous cells compared to normal tissue cells.

Following surgical excision, tissue specimens such as breast lumpectomies, for example, will contain important tissue facets, or margins that must be identified to facilitate initial gross examination of the specimen through to pathology lab examination under a microscope following fixing, paraffin embedding, and sectioning of tissue samples. Commonly, tissue-marking dyes (TMDs) of various distinguishable colors are applied to each margin, which facilitates both macroscopic registration and inspection and microscopic identification of cancer vs normal tissue margin status.

Depending on the margin guidelines in place, a surgeon may immediately mark a resected tumor specimen in order to accurately capture the spatial orientation of the specimen relative to the tumor cavity in the patient's body. This “spatial registration” process is vitally important to ensure the orientation of the tumor specimen is recorded. If a particular margin of a resected specimen is determined to be inadequate (e.g., cancerous tissue present at the tissue surface), the spatial registration informs the surgeon where additional tissue resection is required. A common tissue specimen marking practice involves applying colored inks to surfaces of the resected specimen. For example, a first color ink may be applied to a first surface of the excised specimen to indicate a first lateral surface, a second color ink applied to a second surface to indicate a second lateral surface, a third color ink applied to a third surface to indicate a posterior surface, etc. In lumpectomy surgery for invasive cancer, a guideline followed for a call of “clean” margins is referred to as “no tumor on ink”, a definition that means the cancer tissue cannot be present on the surface of the excised specimen but should be “sub-surface” and covered by a thin layer of normal tissue. A significant issue associated with existing ink marking practices is that the ink makes it difficult if not impossible to use any of the optical sensing approaches outlined above to verify clean margins. Optical properties (e.g., fluorescence) of existing TMDs will likely swamp the optical signal, and existing TMDs cannot locate cancerous tissue by themselves.

What is needed is an improved tissue marking dye, system, and method that can be used to determine tissue properties at the excised tissue margins in addition to providing spatial information with respect to the patient body.

### SUMMARY

According to an aspect of the present disclosure, a tumor responsive tissue marking dye is provided that includes a tissue marking dye and at least one cancer activated agent. The at least one cancer activated agent is configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state.

In any of the aspects or embodiments described above and herein, the tissue marking dye may be configured to produce a fluorescent response when interrogated with an excitation light; and the first state may be photometrically distinguishable from the second state in a spectral domain when interrogated with the excitation light, and the spectral domain is independent of the fluorescent response.

In any of the aspects or embodiments described above and herein, the excitation light may include one or more wavelengths of infrared light, and the spectral domain is infrared light.

In any of the aspects or embodiments described above and herein, the excitation light may include one or more wavelengths of short-wave infrared light, and the spectral domain is short-wave infrared light.

In any of the aspects or embodiments described above and herein, the at least one cancer activated agent may be configured to produce Raman scattering at one or more known wavelengths of light when interrogated with an excitation light, and the spectral domain contains the one or more known wavelengths of light.

In any of the aspects or embodiments described above and herein, the at least one cancer activated agent may include a fluorescent agent that has a first intensity in the first state, and a second intensity in the second state, and the first intensity is different than the first intensity.

In any of the aspects or embodiments described above and herein, the at least one cancer activated agent may reside in the first state in a neutral pH environment and may reside in the second state in an acidic pH environment.

In any of the aspects or embodiments described above and herein, the at least one cancer activated agent may include a fluorescent agent and the fluorescent agent has a first lifetime in the first state and has a second lifetime in the second state, wherein the first lifetime is different than the second lifetime.

In any of the aspects or embodiments described above and herein, the at least one cancer activated agent may include a peptide that has a first Raman spectral signature in the first state and has a second Raman spectral signature in the second state, and the first Raman spectral signature is different than the second Raman spectral signature, and the peptide may be a pH (low) insertion peptide.

In any of the aspects or embodiments described above and herein, the at least one cancer activated agent may include a protease-responsive probe and the protease-responsive probe may have a first fluorescence characteristic in the first state and has a second fluorescence characteristic in the second state, wherein the first fluorescence characteristic is different than the second fluorescence characteristic.

According to an aspect of the present disclosure, a system for identifying the presence or absence of cancerous tissue on a surface of a resected tissue specimen is provided that includes a tumor responsive tissue marking dye (TRTMD), a platform, at least one light source, at least one light detector, and a controller. The tumor responsive tissue marking dye (TRTMD) has a tissue marking dye and at least one cancer activated agent, the at least one cancer activated agent is configured to assume a first state in the absence of cancerous tissue or a microenvironment associated with the cancerous tissue, and a second state in the presence of the cancerous tissue or the microenvironment associated the cancerous tissue. The first state is photometrically distinguishable from the second state. The platform is configured to support a resected tissue specimen. The at least one light source is configured to produce an excitation light. The at least one light detector is configured to detect light emitted from a layer of TRTMD applied to a surface of the resected tissue specimen. The controller is in communication with the at least one light source, the at least one light detector, and a non-transitory memory storing instructions, which instructions when executed cause the controller to: a) control the at least one light source to interrogate a surface of a resected tissue specimen having TRTMD disposed on the surface with the excitation light, the resected tissue specimen disposed on the platform; b) receive signals from the at least one light detector, the signals representative of emitted light resulting from the interrogation, the emitted light detected by the at least one light detector; c) analyze the signals to produce information indicative of the cancer activated agent being in the first or second state; and d) produce information indicative of the presence or absence of cancerous tissue at the surface of the resected tissue specimen based on the information indicative of the cancer activated agent being in the first or second state.

In any of the aspects or embodiments described above and herein, the tissue marking dye may be configured to produce a fluorescent response when interrogated the excitation light, and the first state is photometrically distinguishable from the second state in a spectral domain when interrogated with the excitation light, and the spectral domain is independent of the fluorescent response.

In any of the aspects or embodiments described above and herein, the excitation light may include one or more wavelengths of infrared light, and the spectral domain is infrared light.

In any of the aspects or embodiments described above and herein, the excitation light may include one or more wavelengths of short-wave infrared light, and the spectral domain is short-wave infrared light.

In any of the aspects or embodiments described above and herein, the at least one cancer activated agent may be configured to produce Raman scattering at one or more known wavelengths of light when interrogated with the excitation light, and the spectral domain contains the one or more known wavelengths of light.

In any of the aspects or embodiments described above and herein, the at least one cancer activated agent may include a peptide that has a first Raman spectral signature in the first state and has a second Raman spectral signature in the second state, and the first Raman spectral signature is different than the second Raman spectral signature.

In any of the aspects or embodiments described above and herein, the at least one cancer activated agent may include a protease-responsive probe and the protease-responsive probe has a first fluorescence characteristic in the first state and has a second fluorescence characteristic in the second state, and the first fluorescence characteristic is different than the second fluorescence characteristic.

According to an aspect of the present invention, a method for identifying the presence or absence of cancerous tissue on a surface of a resected tissue specimen is provided. The method includes: a) applying a tumor responsive tissue marking dye (TRTMD) to a surface of a resected tissue specimen, the TRTMD having a tissue marking dye and at least one cancer activated agent, the at least one cancer activated agent configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state; b) interrogating the surface of the resected tissue specimen with an excitation light produced by a light source; c) detecting light emitted from the TRTMD applied to the surface of the resected tissue specimen using a light detector, and producing signals representative of the detected light; d) analyzing the signals using a controller to produce information indicative of the cancer activated agent being in the first or second state; and e) producing information indicative of the presence or absence of cancerous tissue at the surface of the resected tissue specimen based on the information indicative of the cancer activated agent being in the first or second state.

### BRIEF DESCRIPTION OF THE DRAWINGS

FIG. 1 is a diagrammatic illustration of a system embodiment of the present disclosure.

### DISCLOSURE OF THE INVENTION

Aspects of the present disclosure include a new, unobvious tumor responsive tissue marking dye (TRTMD), a system that includes such a TRTMD, and a method for the detection of cancer in the margin region of a resected tissue specimen that utilizes such a TRTMD.

The present disclosure's TRTMDs include a tissue marking dye (TMD) product comprising one or more cancer activated agents which can be utilized to probe/target/identify the presence of cancerous tissue. The present disclosure is not limited to any particular material that may be used as a TMD and may include materials that are commercially produced as TMDs. Commercially available TMDs are produced by several different companies, including Bradley Products, Inc. of Bloomington, Minn. USA; Cancer Diagnostics, inc., of Durham, N.C., USA; General Data Healthcare of Cincinnati, Ohio, USA, etc.

The cancer activated agent is configured to produce an identifiable signal in the presence of cancerous tissue or in the presence of a microenvironment associated with cancerous tissue. For example, it is known that all tumors exhibit an acidic micro-environment, largely due to glycolytic metabolic processes exhibited by cancer cells. To maintain rapid growth and proliferation, cancer cells have a higher need for energy which is to a large degree fulfilled by an increased dependence on alternate metabolic pathways. Under aerobic conditions, cancer cells metabolize glucose to lactic acid, a process generally called the Warburg effect. [9] Tumor tissue is also generally hypoxic (lacking in oxygen), has deficient blood perfusion, and has lower glucose levels. [10] Generally, these characteristics result in a microenvironment is pH of 6.4 to 6.8, whereas the surrounding normal tissue is close to neutral pH (7.2). The extracellular microenvironment acidity of cancer is associated with tumor progression and tumor metastasis. [10-11] Hence, an acidic microenvironment is an example of a microenvironment associated with cancerous tissue. Other microenvironment characteristics indicative of cancerous tissue may be used alternatively.

The signal produced by the cancer activated agent is identifiable relative to optical properties (e.g., fluorescence, Raman scattering, etc.) of the TMD present within the TRTMD. For example, the identifiable signal produced by the cancer activated agent may be in a particular spectral domain; e.g., in a spectral domain where the signal is identifiable with minimal interference by the optical properties (e.g., color, fluorescence, Raman scattering, etc.) of the TMD present within the TRTMD. A cancer activated agent may include an element that undergoes an identifiable change in the presence of cancerous tissue or in the presence of a microenvironment associated with cancerous tissue or has the specific ability to bind specifically with cancer cells. The aforesaid “identifiable change” may be described as the cancer activated agent assuming a first state in the absence of cancerous tissue or a microenvironment associated with cancerous tissue, and assuming a second state in the presence of cancerous tissue or a microenvironment associated with cancerous tissue. The first state is distinguishable from the second state; e.g., the identifiable signal produced by the cancer activated agent in a particular spectral domain changes from the first state to the second state in the presence of cancerous tissue and that change is identifiable with minimal interference by the optical properties. Preferably, but not necessarily, the presence of the cancer activated agent within the TRTMD has little or no effect on the color appearance of the TMD within the visible spectrum. Many TRDs are well-known, and clinicians are accustomed to working with the commonly available TRD colors. Hence, it is likely preferable to a clinician that the TRTMD be available in colors to which they are accustomed.

As a specific example, a cancer activated agent may include a fluorophore that has a first response to near-infrared (MR) excitation light (e.g., light within a MR band of about 750-1100 nm) in the absence of cancerous tissue or a microenvironment associated with cancerous tissue and have a second response to NIR excitation light in the presence of cancerous tissue or a microenvironment associated with cancerous tissue. The second response is distinguishable from the first response. As another example, a cancer activated agent may include a fluorophore that has a first response to short-wave infrared (SWIR) excitation light (e.g., light within a SWIR band of about 900-1700 nm) in the absence of cancerous tissue or a microenvironment associated with cancerous tissue and has a second response to SWIR excitation light in the presence of cancerous tissue or a microenvironment associated with cancerous tissue. In some embodiments, the second response of a cancer activated agent may be a fluorescent quenching that is identifiable. Examination of the TRTMD (containing the cancer activated agent) in one of these spectral domains will permit a determination of the presence or absence of cancerous tissue or a microenvironment associated with cancerous tissue based on the first or second response. If cancerous tissue is indicated, the TRTMD also provides the location of the cancerous tissue. This information can be used by a clinician to determine in a relatively short period of time whether appropriate tumor margin is present or not, and if not, where cancerous tissue is located.

The different photometric responses such as changes in absorption, scattering, or emission produced by the cancer activated agent (i.e., “modulated” responses based on the presence or absence of cancerous tissue) may take multiple different forms, including but not limited to a change in fluorescent intensity, a change in fluorescent wavelength dependence, a change in fluorescent lifetime, or the like. In some embodiments, multiple or combination of various photometric changes in TRTMDs may be utilized.

In some embodiments, the cancer activated agent may be integral part of the TMD itself. For instance, one or more molecular constituents used in a TMD formulation (e.g., an existing TMD formulation) may be modified to contain a cancer activated agent. Nonlimiting example of such as TMD could be a cancer-responsive fluorescence/Raman probe attached to a TMD molecule that produces a changed photometric response in the presence of cancerous tissue.

Examples of a cancer activated agents that change the intensity of a fluorescent agent in the presence of cancerous tissue or a microenvironment associated with cancerous tissue include a pH responsive nanoparticle which dissembles above a particular transition pH (sometimes referred to as a “pH Transistor” mechanism”) as described in U.S. Patent Publication No. 2018/0369424 by Gao et al (which is hereby incorporated by reference in its entirety), or “A transistor-like pH nanoprobe for tumor detection and image-guided surgery” as disclosed by Zhao et al., [12], or pH-tunable, highly activatable, multicolored fluorescent nanoparticles using commonly available pH-insensitive dyes with emission wavelengths from green into the near IR range as disclosed by Zhou et al. [13], or the like.

Examples of cancer activated agents that change the spectrum of the fluorescence agent include the use of a pH sensitive dye, such as a seminaphtharhodafluor (SNARF) dye within an ink matrix as disclosed by Tseng et al. [14], or other pH-wavelength dependent mechanisms as disclosed by Korzeniowska et al. [15].

An example of a cancer activated agent that changes the lifetime of a fluorescence agent as a function of pH, and more specifically modulation of the fluorescence lifetime of quantum dots by pH, is disclosed by Tan et al. [16].

An example of cancer activated agent includes a protease-responsive probe including a fluorescence probe whose attributes such as intensity, lifetime, fluorescence resonance energy transfer (FRET) etc. may be utilized to detect cancer.

The above examples of “modulated” fluorescent responses based on the presence or absence of cancerous tissue are intended to be non-limiting and are provided to illustrate the scope of possible cancer activated agents.

In some embodiments, the identifiable signal produced by the cancer activated agent may involve a Raman spectral signature change. An example of a mechanism for changing the Raman spectral signature of a cancer activated agent includes the differential modulation of spectral components derived from SERS-based amplification of target compounds functionalized to the surface of SERS substrates. This can be accomplished via competitive binding of certain analytes such as tagged anti-bodies. [17], [18]

In some embodiments, a cancer activated agent may include a peptide such as a pH sensing peptide, commonly referred to as a pH (low) insertion peptide or “pHLIP”. pHLIPs are based on an amino acid sequence that reversibly folds and can insert across cell membranes in response to local intra-cellular low pH conditions such as those associated with cancerous tissue. The Raman spectral signature of pHLIPs in an acidic microenvironment like that associated with cancerous tissue is distinguishable from pHLIPs disposed in a pH neutral environment and is distinguishable from the optical properties of the tissue marking dye. [19], [20]

In alternative embodiments of the present disclosure, the spectral modulation mechanisms discussed above (i.e., from a first state to a second state where the first state is distinguishable from the second state) may be: a) used to create imaging tumor-induced changes in IR reflectivity/absorption (e.g., in the SWIR band); b) applied to quantum dots—designed to interact to the cancer microenvironment, pH or other biomarkers [21]; or c) used to create imaging changes induced in the Terahertz range induced by, for example, pH-induced structural changes in nanomaterials applied as part of the ink. These nano-materials would otherwise have no effect on the visible optical properties of the inks, and this would preserve their use as margin-indicators for pathological assessment.

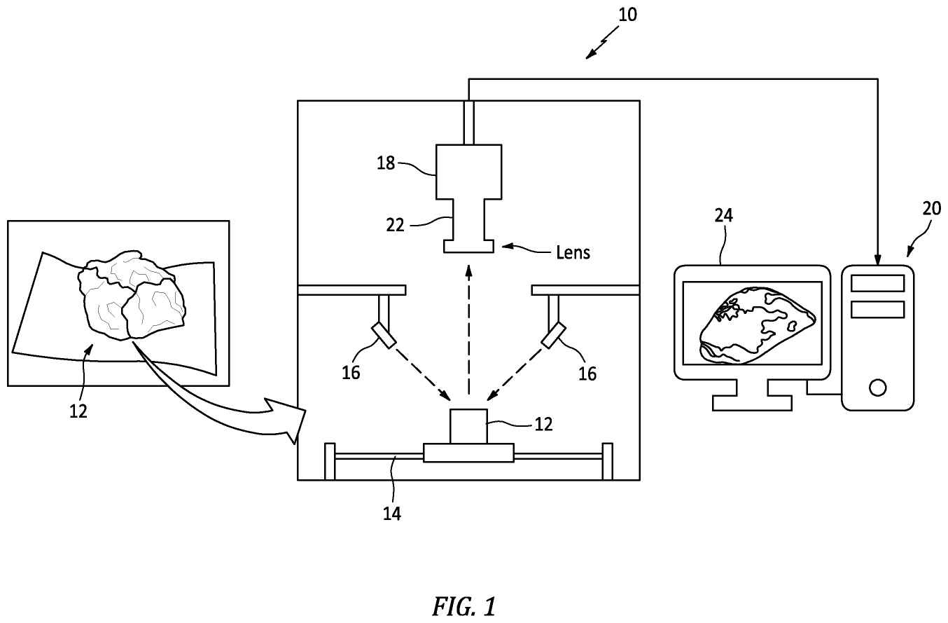

FIG. 1 diagrammatically illustrates a present disclosure system 10 that may be used to examine a resected tissue specimen 12 using a TRTMD. The system 10 includes a platform 14 for supporting the resected tissue specimen 12, one or more lights sources 16 (e.g., LEDs, lasers, etc.) for interrogating the resected tissue specimen 12, a light detector 18 (e.g., a camera), and a controller 20. In some embodiments, the platform 14 may be controllable in an X-Y plane to facilitate examination of the resected tissue specimen 12. The one or more light sources 16 are configured to produce light used in the examination; e.g., the light sources 16 may be configured to produce MR excitation light if a TRTMD contains a cancer activated agent having a fluorophore responsive to NIR excitation light, or the light sources 16 may be configured to produce SWIR excitation light if a TRTMD contains a cancer activated agent having a fluorophore responsive to SWIR excitation light, etc. Alternatively, the lights sources 16 may be configured to produce light at wavelengths that produce a Raman spectrum response from the cancer activated agent that is indicative of a second state response if cancerous tissue or a microenvironment associated with cancerous tissue is present. These are non-limiting examples of interrogating light spectrums that may be produced by the light sources 16. The light detector 18 is configured to detect light (e.g., fluorescent light or Raman scattering) emitted from the resected tissue specimen 12 as a result of the light interrogation. In those embodiments wherein the TRTMD is configured to detect cancerous tissue based on Raman spectroscopy principles, the system 10 may include a spectrometer 22, or optical devices that may provide functionality similar to that provided by a spectrometer (e.g., dispersing elements, optical filters, etc.). The exemplary system diagrammatically shown in FIG. 1 shows a camera as a light detector 18. The present system 20 is not limited to using a camera as a light detector 18. In some embodiments, the controller 20 controls the platform 14 to position the resected tissue specimen 12 relative to the light sources 16 and the light detector 18, operate the light sources 16, and the light detector 18 to produce signals having spatial information to permit spatial identification of emitted signals relative to the resected tissue specimen 12. The light detector 18 produced signals representative of the emitted light (and spatial information) are communicated to the controller 20.

The controller 20 is in communication with other components within the system 10, such as the light sources 16, the light detector 18, and the like to control and/or receive signals therefrom to perform the functions described herein. The controller 20 may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system 10 to accomplish the same algorithmically and/or coordination of system components. The controller 20 may include a single memory device or a plurality of memory devices. The present disclosure is not limited to any particular type of non-transitory memory device. The controller 20 may include, or may be in communication with, an input device that enables a user to enter data and/or instructions, and may include, or be in communication with, an output device 24 configured, for example to display information (e.g., a visual display or a printer), or to transfer data, etc. Communications between the controller 20 and other system components may be via a hardwire connection or via a wireless connection.

In some embodiments, the controller 20 may be configured to control the various system components to automatically scan each surface of a resected tissue specimen 12, or alternatively the system 10 may be configured to allow the clinician to selectively scan desired tissue surfaces or portions thereof.

The controller 20 is configured (e.g., via stored instructions) to use the signals provided from the light detector 18 to produce information (e.g., an image) that indicates the presence of cancerous tissue at the surface of the resected tissue specimen 12 and preferably the location of that cancerous tissue. The information provided by the controller 20 may be in a variety of different forms; e.g., an image, data values, mapping coordinates, or the like, or any combination thereof. The aforesaid information may be communicated to an output device 24 (e.g., a display, a printer, or the like) for communication to the clinician. A benefit of the present disclosure is the speed at which such information can be provided to a clinician. In some instances, the information may be utilized by the clinician shortly after the resected tissue specimen was removed to inform the clinician regarding the adequacy of the tumor resection.

An example of how the present disclosure may be applied as a method includes applying one or more TRTMDs to different surfaces of a resected tissue specimen understood to be cancerous; e.g., a first TRTMD may be applied to a first surface of a resected tissue specimen to indicate a first lateral surface, a second TRTMD may be applied to a second surface to indicate a second lateral surface, a third TRTMD may be applied to a third surface to indicate a posterior surface, etc. The TRTMD dyed resected tissue specimen may then be examined using a present disclosure system such as that described above. The clinician examining the resected tissue specimen may operate the system to interrogate one or more surfaces of the resected tissue specimen that have been dyed with a TRTMD with excitation light. The light emitted from the interrogated tissue is detected by the light detector and signals representative of the emitted light are processed by the controller (e.g., via stored instructions) to produce information (e.g., an image, data values, mapping, etc.) indicative of the presence or absence of cancerous tissue at the scanned surface. If the presence of cancerous tissue at the surface of the resected tissue specimen is determined, the controller may be configured to produce images, mapping coordinates, or the like, or any combination thereof to an output device (e.g., a display, a printer, or the like) for communication to the clinician.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

### REFERENCES

1. Nguyen and Tsien, “Fluorescence-guided surgery with live molecular navigation—a new cutting edge”, Nat Rev Cancer, 13(9), pp. 653-662, 2013.
2. Tummers, et al., “Real-time intraoperative detection of breast cancer using near-infrared fluorescence imaging and methylene blue”, Eur J Surg Oncol., 40(7), 850-858, 2014.
3. Dahr et al., “A diffuse reflectance spectral imaging system for tumor margin assessment using custom annular photodiode arrays”, Biomedical Optics Express, 3, (12), 2012.
4. Harmsen et al., “Cancer imaging using surface-enhanced resonance Raman scattering nanoparticles”, Nat Protoc.; 11(4): 664-87, 2016
5. Pence I., Mahadevan-Jansen A., “Clinical instrumentation and applications of Raman spectroscopy”, Chem Soc Rev.; 45 (7):1958-1979, 2016.
6. Talari, A. et al., “Raman Spectroscopy of Biological Tissues”, Applied Spectroscopy Reviews, 50:1, 46-111, 2015.
7. Yaroslaysky. A, et al., “Delineating nonmelanoma skin cancer margins using terahertz and optical imaging”, J of Biomedical Photonics & Eng., 3(1), 2017.
8. Ifa and Eberlin, “Ambient Ionization Mass Spectrometry for Cancer Diagnosis and Surgical Margin Evaluation”, Clin Chem.; 62(1), 2016.
9. Volynskaya et al., “Diagnosing breast cancer using diffuse reflectance spectroscopy and intrinsic fluorescence spectroscopy”, Journal of Biomedical Optics 13, 2, 024012, (2008).
10. Nguyen et al., “Near-infrared autofluorescence spectroscopy of in vivo soft tissue sarcomas”, Opt Lett. 2015 Dec. 1; 40(23): 5498-5501.
11. Nguyen et al., “Development of a modular fluorescence overlay tissue imaging system for wide-field intraoperative surgical guidance”, J Med Imaging, 2018 5(2):021220.
12. T. Zhao et al., “A transistor-like pH nanoprobe for tumor detection and image-guided surgery”, Nature Biomedical Engineering, 1, 0006 (2016).
13. Zhou et al., “Multicolored pH-tunable and activatable fluorescence nanoplatform responsive to physiologic pH stimuli,” Journal of the American Chemical Society, 134:7803-7811, 2012
14. Tseng et al., “In Vivo Fluorescent Labeling of Tumor Cells with the HaloTag® Technology”, Current Chemical Genomics, 6, (Suppl 1-M6) pp. 48-54, 2012
15. Korzeniowska et al., “Intracellular pH-sensing using core/shell silica nanoparticles”, J Biomed Nanotechnol., 10(7), pp. 1336-45, 2014
16. Tan et al., “Induction of pH sensitivity on the fluorescence lifetime of quantum dots by NIR fluorescent dyes”, J. Am. Chem. Soc., 134, 4545-4548 (2012)
17. C. W. Barth et al., “Optimizing fresh specimen staining for rapid identification of tumor biomarkers during surgery”, J Biomed Opt., 24(2), 2019
18. Wang Y, et al. “Quantitative molecular phenotyping with topically applied SERS nanoparticles for intraoperative guidance of breast cancer lumpectomy”, Sci Rep. 2016; 6: 21242.
19. Andreev, et al., “pH-sensitive membrane peptides (pHLIPs) as a novel class of delivery agents”, Mol. Membr. Biol., 27, pp. 341-352, 2010
20. Werakkoddy et al., “Novel pH-Sensitive Cyclic Peptides”, Scientific Reports, 6, 2016.
21. Gao et al., “In vivo cancer targeting and imaging with semiconductor quantum dots”, Nature Biotechnology, 22 (8), pp. 969-976, 2004

1. A tumor responsive tissue marking dye, comprising:
a tissue marking dye; and
at least one cancer activated agent configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state.

2. The tumor responsive tissue marking dye of claim 1, wherein the tissue marking dye is configured to produce a fluorescent response when interrogated with an excitation light; and
wherein the first state is photometrically distinguishable from the second state in a spectral domain when interrogated with the excitation light, and the spectral domain is independent of the fluorescent response.

3. The tumor responsive tissue marking dye of claim 2, wherein the excitation light includes one or more wavelengths of infrared light, and the spectral domain is infrared light.

4. The tumor responsive tissue marking dye of claim 2, wherein the excitation light includes one or more wavelengths of short-wave infrared light, and the spectral domain is short-wave infrared light.

5. The tumor responsive tissue marking dye of claim 2, wherein the at least one cancer activated agent is configured to produce Raman scattering at one or more known wavelengths of light when interrogated with an excitation light, and the spectral domain contains the one or more known wavelengths of light.

6. The tumor responsive tissue marking dye of claim 1, wherein the at least one cancer activated agent includes a fluorescent agent that has a first intensity in the first state, and a second intensity in the second state, and the first intensity is different than the first intensity.

7. The tumor responsive tissue marking dye of claim 1, wherein the at least one cancer activated agent resides in the first state in a neutral pH environment and resides in the second state in an acidic pH environment.

8. The tumor responsive tissue marking dye of claim 7, wherein the at least one cancer activated agent includes a fluorescent agent and the fluorescent agent has a first lifetime in the first state and has a second lifetime in the second state, wherein the first lifetime is different than the second lifetime.

9. The tumor responsive tissue marking dye of claim 1, wherein the at least one cancer activated agent includes a peptide that has a first Raman spectral signature in the first state and has a second Raman spectral signature in the second state, and the first Raman spectral signature is different than the second Raman spectral signature.

10. The tumor responsive tissue marking dye of claim 9, wherein the peptide is a pH (low) insertion peptide.

11. The tumor responsive tissue marking dye of claim 1, wherein the at least one cancer activated agent includes a protease-responsive probe and the protease-responsive probe has a first fluorescence characteristic in the first state and has a second fluorescence characteristic in the second state, wherein the first fluorescence characteristic is different than the second fluorescence characteristic.

12. A system for identifying the presence or absence of cancerous tissue on a surface of a resected tissue specimen, the system comprising:
a tumor responsive tissue marking dye (TRTMD) having a tissue marking dye and at least one cancer activated agent, the at least one cancer activated agent configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state;
a platform for supporting a resected tissue specimen;
at least one light source configured to produce an excitation light;
at least one light detector configured to detect light emitted from a layer of TRTMD applied to a surface of the resected tissue specimen; and
a controller in communication with the at least one light source, the at least one light detector, and a non-transitory memory storing instructions, which instructions when executed cause the controller to:
control the at least one light source to interrogate a surface of a resected tissue specimen having said TRTMD disposed on the surface with the excitation light, the resected tissue specimen disposed on the platform;
receive signals from the at least one light detector, the signals representative of emitted light resulting from the interrogation, the emitted light detected by the at least one light detector;
analyze the signals to produce information indicative of the cancer activated agent being in said first state or said second state; and
produce information indicative of the presence or absence of cancerous tissue at the surface of the resected tissue specimen based on the information indicative of the cancer activated agent being in said first state or said second state.

13. The system of claim 12, wherein the tissue marking dye is configured to produce a fluorescent response when interrogated the excitation light; and
wherein the first state is photometrically distinguishable from the second state in a spectral domain when interrogated with the excitation light, and the spectral domain is independent of the fluorescent response.

14. The system of claim 13, wherein the excitation light includes one or more wavelengths of infrared light, and the spectral domain is infrared light.

15. The system of claim 13, wherein the excitation light includes one or more wavelengths of short-wave infrared light, and the spectral domain is short-wave infrared light.

16. The system of claim 13, wherein the at least one cancer activated agent is configured to produce Raman scattering at one or more known wavelengths of light when interrogated with the excitation light, and the spectral domain contains the one or more known wavelengths of light.

17. The system of claim 12, wherein the at least one cancer activated agent includes a peptide that has a first Raman spectral signature in the first state and has a second Raman spectral signature in the second state, and the first Raman spectral signature is different than the second Raman spectral signature.

18. The system of claim 12, wherein the at least one cancer activated agent includes a protease-responsive probe and the protease-responsive probe has a first fluorescence characteristic in the first state and has a second fluorescence characteristic in the second state, wherein the first fluorescence characteristic is different than the second fluorescence characteristic.

19. A method for identifying the presence or absence of cancerous tissue on a surface of a resected tissue specimen, the method comprising:
applying a tumor responsive tissue marking dye (TRTMD) to a surface of a resected tissue specimen, the TRTMD having a tissue marking dye and at least one cancer activated agent, the at least one cancer activated agent configured to assume a first state in the absence of cancerous tissue or a microenvironment associated with said cancerous tissue, and a second state in the presence of said cancerous tissue or said microenvironment associated with said cancerous tissue, wherein the first state is photometrically distinguishable from the second state;
interrogating the surface of the resected tissue specimen with an excitation light produced by a light source;
detecting light emitted from the TRTMD applied to the surface of the resected tissue specimen using a light detector, and producing signals representative of the detected light;
analyzing the signals using a controller to produce information indicative of the cancer activated agent being in said first state or said second state; and
producing information indicative of the presence or absence of cancerous tissue at the surface of the resected tissue specimen based on the information indicative of the cancer activated agent being in said first state or said second state.
